(19) United States
(12) Patent Application Publication
(10) Pub. No.: US 2023/0139066 A1
(43) Pub. Date: May 4, 2023

(54) IMAGE SENSING APPARATUS

(71) Applicant: Egis Technology Inc., Hsinchu City (TW)

(72) Inventor: Tzu-Li Hung, Hsinchu City (TW)

(73) Assignee: Egis Technology Inc., Hsinchu City (TW)

(21) Appl. No.: 17/802,539

(22) PCT Filed: Dec. 22, 2020
(86) PCT No.: PCT/CN2020/138327

§ 371 Date: Aug. 26, 2022

Related U.S. Application Data
(60) Provisional application No. 63/003,308, filed on Apr. 1, 2020.

(51) Int. Cl. H04N 25/53; H04N 25/78

(52) U.S. Cl. CPC H04N 25/53; H04N 25/78

(57) ABSTRACT

Disclosed is an image sensing apparatus. A light sensing unit receives a light signal including image information in order to generate a sensing signal. An integrator circuit conducts an integral operation on the sensing signal during integration, so as to accumulate the sensing signals in order to generate an accumulative sensing value falling within a default range.

### BACKGROUND

### Technical Field

The disclosure relates to a sensing apparatus, and more particularly, to an image sensing apparatus.

### Description of Related Art

A common image sensing apparatus may include a sensing pixel array formed by multiple sensing pixels. Each of the sensing pixels may convert incident light into a sensing signal. By analyzing the sensing signal provided by each of the sensing pixels, an image sensed by the image sensing apparatus may be obtained. Further, each of the sensing pixels may include a photodiode, which converts light into an electrical signal. Continuous exposure of the photodiode will cause a voltage value of the sensing signal output by the sensing pixel to drop continuously. By reading the voltage value of the sensing signal provided by each of the sensing pixels, the image sensed by the image sensing apparatus may be obtained. However, when the exposure amount is too small (e.g., the exposure time is too short), that is, the voltage value of the sensing signal is too small, resolution of a reading circuit may be insufficient, and the sensing signal may not be read correctly. Generally, a sampling interval of the sensing signal may be prolonged to wait for the voltage value of the sensing signal to increase with time before sampling, or the reading circuit with higher resolution may be used to ensure that the reading circuit may correctly read the sensing signal. Although these two methods may improve an issue that the sensing signal may not be read correctly when the exposure of the sensing pixels is insufficient, issues of reducing sensing efficiency of the image sensing apparatus or increasing production cost arise.

### SUMMARY

The disclosure provides an image sensing apparatus, which may effectively improve the image sensing quality.

An image sensing apparatus in the disclosure includes a light sensing unit and an integrator circuit. The light sensing unit receives a light signal including image information to generate a sensing signal. The integrator circuit is coupled to the light sensing unit and conducts an integral operation on the sensing signal during integration, so as to accumulate the sensing signals to generate an accumulative sensing value falling within a default range.

Based on the above, the integrator circuit in this embodiment of the disclosure may conduct the integral operation on the sensing signal during the integration, and accumulate the sensing signals to generate the accumulative sensing value falling within the default range. In this way, by accumulating the sensing signals provided by the light sensing unit at different time points during the integration, it may avoid the situation where the signal value of the sensing signal is too small and the subsequent signal processing circuit may not read the sensing signal correctly due to the insufficient resolution. Therefore, the image sensing quality may be effectively and significantly improved.

In order for the aforementioned features and advantages of the disclosure to be more comprehensible, embodiments accompanied with drawings are described in detail below.

### BRIEF DESCRIPTION OF THE DRAWINGS

FIG. 1 is a schematic view of an image sensing apparatus according to an embodiment of the disclosure.

FIG. 2 is a schematic view of an image sensing apparatus according to another embodiment of the disclosure.

FIG. 3 is a schematic view of an image sensing apparatus according to another embodiment of the disclosure.

FIG. 4 is a schematic view of an image sensing apparatus according to another embodiment of the disclosure.

FIG. 5 is a schematic view of an image sensing apparatus according to another embodiment of the disclosure.

FIG. 6 is a schematic view of waveforms of a reset signal and a control signal according to an embodiment of the disclosure.

FIG. 7 is a schematic view of an image sensing apparatus according to another embodiment of the disclosure.

### DETAILED DESCRIPTION OF DISCLOSED EMBODIMENTS

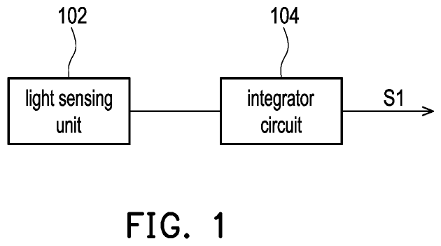

FIG. 1 is a schematic view of an image sensing apparatus according to an embodiment of the disclosure. Referring to FIG. 1, the image sensing apparatus may include a light sensing unit 102 and an integrator circuit 104. The light sensing unit 102 is coupled to the integrator circuit 104. The image sensing apparatus may be, for example, a fingerprint sensor or an X-ray tablet sensor, but the disclosure is not limited thereto. The light sensing unit 102 may receive a light signal including image information to generate a sensing signal. The integrator circuit 104 may conduct an integral operation on the sensing signal generated by the light sensing unit 102 during integration, so as to accumulate the sensing signals to generate an accumulative sensing value S1 falling within a default range. That is, the integrator circuit 104 may continuously sample the sensing signal multiple times during the integration, and amplify the sensing signal by accumulating the sampled values. In this way, in the case where an exposure amount of the light sensing unit 102 is small, the integrator circuit 104 may still provide the sufficiently large accumulative sensing value S1 to a post-stage circuit (such as an analog-to-digital conversion circuit, a digital signal processing circuit, etc.), which may effectively prevent the post-stage circuit from being unable to correctly read the sensing signal due to insufficient resolution, and does not reduce sensing efficiency of the image sensing apparatus or increase production cost.

In some embodiments, the integrator circuit 104 may also reduce a sampling number of the sensing signal when the exposure amount of the light sensing unit 102 is too large, thereby reducing the accumulative sensing value S1 and preventing the accumulative sensing value S1 from exceeding a dynamic range of the post-stage circuit and unable to read the sensing signal correctly.

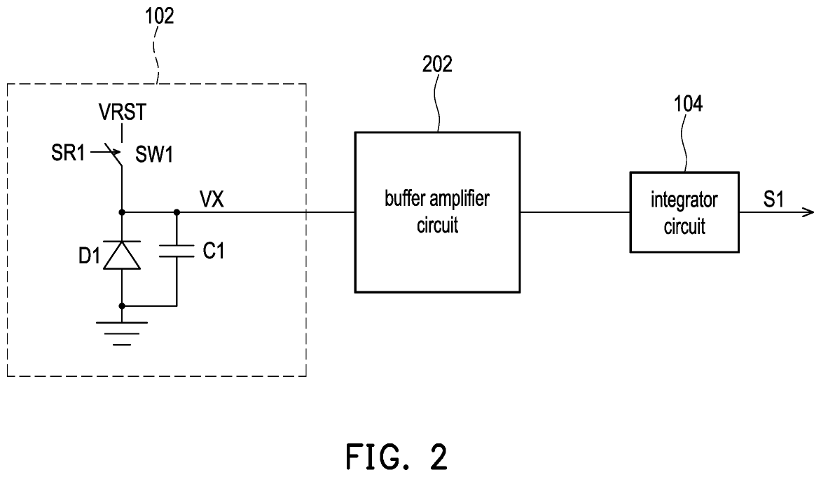

FIG. 2 is a schematic view of an image sensing apparatus according to another embodiment of the disclosure. Further, the light sensing unit 102 may include a reset switch SW1, a photoelectric conversion unit D1, and a parasitic capacitance C1. One end of the reset switch SW1 is coupled to a reset voltage VRST. The photoelectric conversion unit D1 is coupled between the reset switch SW1 and a ground. The parasitic capacitance C1 is generated between a common contact of the photoelectric conversion unit D1 and the reset switch SW1 and the ground. The photoelectric conversion unit D1 may be, for example, a photodiode, but the disclosure is not limited thereto. In addition, compared to the embodiment of FIG. 1, the image sensing apparatus in this embodiment further includes a buffer amplifier circuit 202, and the buffer amplifier circuit 202 is coupled between the light sensing unit 102 and the integrator circuit 104.

When the reset switch SW1 is controlled by a reset signal SR1 to be in a turned-on state, the reset voltage VRST may reset a voltage VX on the common contact of the photoelectric conversion unit D1 and the reset switch SW1 through the reset switch SW1. After entering the integration, the reset switch SW1 is controlled by the reset signal SR1 to enter a turned-off state, and the photoelectric conversion unit D1 converts the light signal into an electrical signal (the sensing signal). At this time, the voltage VX will decrease as the exposure time of the photoelectric conversion unit D1 is prolonged. The buffer amplifier circuit 202 may be, for example, a unit gain amplifier. The buffer amplifier circuit 202 may be used as a signal relay circuit to transmit the sensing signal provided by the light sensing unit 102 to the integrator circuit 104, so as to ensure that the integrator circuit 104 may receive the undistorted sensing signal for the integral operation. A method of conducting the integral operation of the integrator circuit 104 has been described in the above embodiment, and the same details will not be repeated in the following.

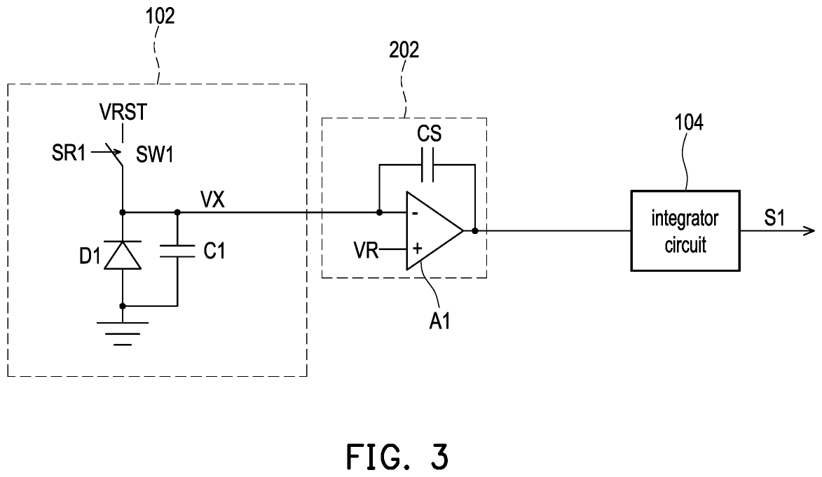

FIG. 3 is a schematic view of an image sensing apparatus according to another embodiment of the disclosure. In this embodiment, the buffer amplifier circuit 202 may include an operational amplifier A1 and a sampling capacitance CS. A positive input end of the operational amplifier A1 is coupled to a reference voltage VR, and a negative input end of the operational amplifier A1 is coupled to an output end of the light sensing unit 102. An output end of the operational amplifier A1 is coupled to the integrator circuit 104, and the sampling capacitance CS is coupled between the negative input end and the output end of the operational amplifier A1. A voltage value of the sensing signal provided by the buffer amplifier circuit 202 to the integrator circuit 104 may be adjusted by changing a voltage value of the reference voltage VR, so that an adjustment of the accumulative sensing value of the integrator circuit 104 is more flexible.

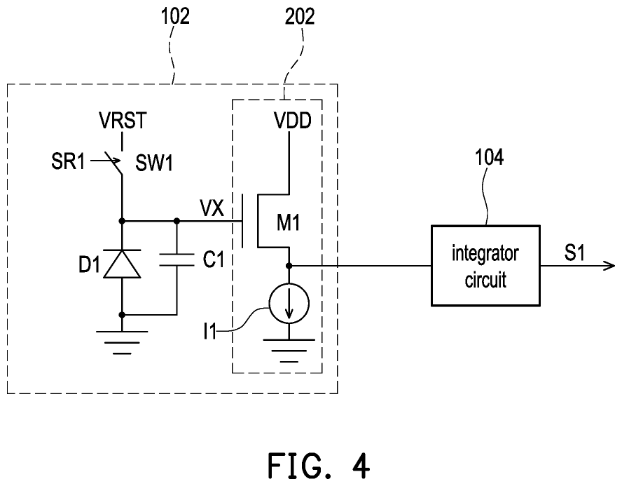

In the above embodiment, the light sensing unit 102 may be disposed on a light sensing panel, and the buffer amplifier circuit 202 and the integrator circuit 104 may be integrated into an IC chip outside the light sensing panel. In this way, more area of the light sensing panel may be freed to dispose the light sensing unit 102, and light sensing efficiency of the light sensing panel may be improved. In some embodiments, the buffer amplifier circuit 202 may also be disposed on the light sensing panel, that is, the light sensing unit 102 also includes the buffer amplifier circuit 202. For example, FIG. 4 is a schematic view of an image sensing apparatus according to another embodiment of the disclosure. In this embodiment, the buffer amplifier circuit 202 in the light sensing unit 102 may include a source follower formed by a transistor M1 and a current source I1. The transistor M1 is coupled between the output end of the light sensing unit 102 and a supply voltage VDD. A gate end of the transistor M1 is coupled to the common contact of the reset switch SW1 and the photoelectric conversion unit D1. The current source I1 is coupled between the transistor M1 and the ground. The transistor M1 may output the sensing signal to the integrator circuit 104 in response to the voltage VX on the common contact of the photoelectric conversion unit D1 and the reset switch SW1, so as to ensure that the integrator circuit 104 may receive the undistorted sensing signal for the integral operation. The method of conducting the integral operation of the integrator circuit 104 has been described in the above embodiment, and the same details will not be repeated in the following.

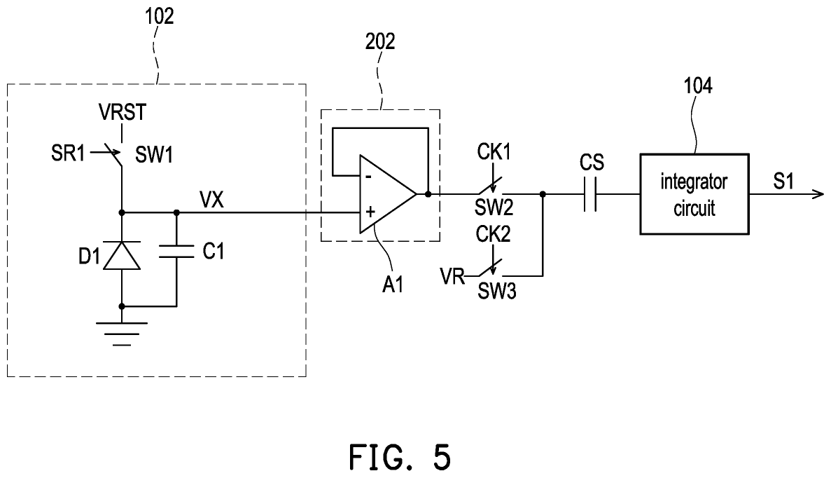

FIG. 5 is a schematic view of an image sensing apparatus according to another embodiment of the disclosure. Compared to the embodiment of FIG. 3, the image sensing apparatus in this embodiment further includes switches SW2 and SW3 and the sampling capacitance CS, and the buffer amplifier circuit 202 only includes the operational amplifier A1. The positive input end of the operational amplifier A1 is coupled to the output end of the light sensing unit 102, and the negative input end of the operational amplifier A1 is coupled to the output end thereof. The switch SW2 is coupled between the output end of the operational amplifier A1 and one end of the sampling capacitance CS. The other end of the sampling capacitance CS is coupled to the integrator circuit 104. The switch SW3 is coupled between a common contact of the switch SW2 and the sampling capacitor CS and the reference voltage VR. The switch SW2 and the switch SW3 may be alternately turned on under the control of corresponding control signals CK1 and CK2 respectively.

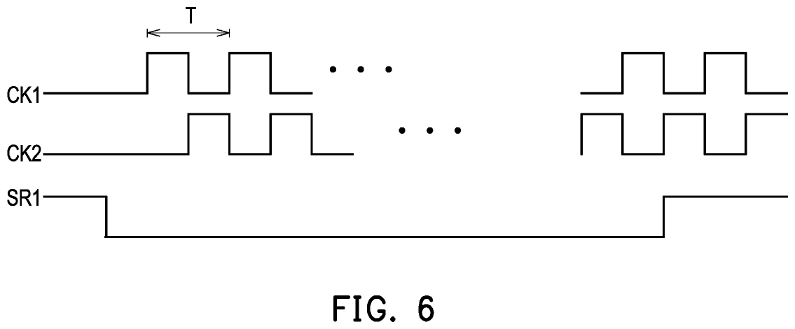

Further, as signal waveforms of the reset signal SR1 and the control signals CK1 and CK2 shown in FIG. 6, during the integration of the integrator circuit 104, the reset signal SR1 is at a low voltage level, so that the reset switch SW1 is in the turned-off state. During the integration of the integrator circuit 104, the control signals CK1 and CK2 may alternately enter a high voltage level, that is, when the control signal CK1 is at the high voltage level, the control signal CK2 is at the low voltage level, and the switch SW2 and the switch SW3 are alternately turned on. When the switch SW2 is turned on, and the switch SW3 is turned off, the buffer amplifier circuit 202 may store the sensing signal in the sampling capacitance CS through the switch SW2. When the switch SW2 is turned off, and the switch SW3 is turned on, the switch SW3 connects the reference voltage VR to the sampling capacitance, and then transmits the sensing signal stored in the sampling capacitance CS to the integrator circuit 104 for the integral operation.

It is assumed that the voltage values of the reference voltage VR and the reset voltage VRST are equal, and the voltage VX decreases linearly. For example, a voltage difference dropped during each cycle time T of the control signals CK1 and CK2 is dV, and a voltage output by the buffer amplifier circuit 202 also drops by dV correspondingly. After the switch SW2 and the switch SW3 are turned on alternately for the first time, the sampling capacitance CS may output the voltage difference dV to the integrator circuit 104. Since continuous exposure of the light sensing unit 102 will cause the voltage output by the buffer amplifier circuit 202 to drop continuously, after the switch SW2 and the switch SW3 are turned on alternately for the second time, the sampling capacitance CS may output a voltage difference of 2dV to the integrator circuit 104, and the rest may be derived by analog. The integrator circuit 104 may accumulate the voltage differences from the sampling capacitance CS, and output the accumulative sensing value S1 accordingly. For example, assuming that the switch SW2 and the switch SW3 are turned on alternately for n times, the accumulative sensing value S1 output by the integrator circuit 104 may be represented by the following formula (1).

dV+2×dV+3×dV+ . . . +n×dV=n(n+1)/2×dV (1)

Compared to the existing image sensing apparatus in which the sensing signal is only sampled once, and at most a sensing value with the voltage value equal to n×dV may be obtained (that is, sampling is conducted after n cycle times T), the image sensing apparatus in this embodiment may effectively amplify the sensing signal, prevent the post-stage circuit from being unable to correctly read the sensing signal due to the insufficient resolution, and does not reduce the sensing efficiency of the image sensing apparatus or increase the production cost.

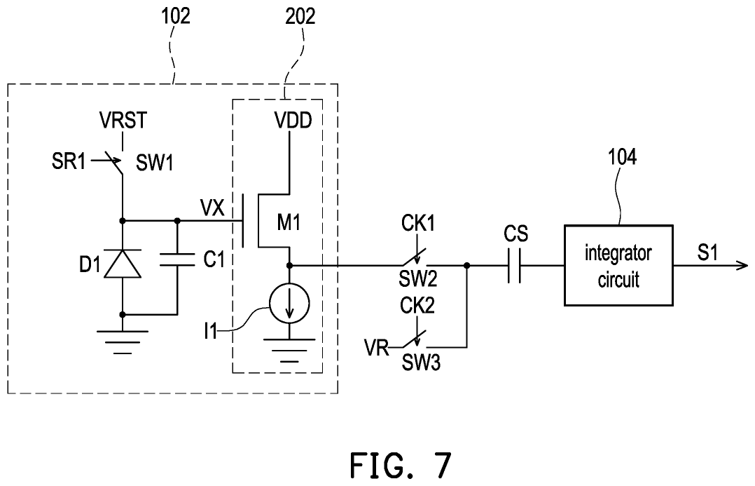

Similarly, the buffer amplifier circuit 202 in the embodiment of FIG. 6 may also be disposed in the light sensing unit 102 as in the embodiment of FIG. 4. As shown in FIG. 7, a common contact of the transistor M1 and the current source I1 in the buffer amplifier circuit 202 may be coupled to the switch SW2. In the image sensing apparatus in this embodiment, the switches SW2 and SW3 may be turned on alternately, so that the sampling capacitance CS outputs the voltage difference correspondingly to the integrator circuit 104 for the integral operation. Since operations of the buffer amplifier circuit 202 including the transistor M1 and the current source I1, the switches SW2 and SW3, the sampling capacitance, and the integrator circuit 104 have already been described in the above embodiments, and the same details will not be repeated in the following.

Based on the above, the integrator circuit in this embodiment of the disclosure may conduct the integral operation on the sensing signal during the integration, and accumulate the sensing signals to generate the accumulative sensing value falling within the default range. In this way, by accumulating the sensing signals provided by the light sensing unit at different time points during the integration, it may avoid the situation where the signal value of the sensing signal is too small and the subsequent signal processing circuit may not read the sensing signal correctly due to the insufficient resolution. Therefore, the image sensing quality may be effectively and significantly improved without reducing the sensing efficiency of the image sensing apparatus or increasing the production cost.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

1. An image sensing apparatus, comprising:
a light sensing unit receiving a light signal comprising image information to generate a sensing signal; and
an integrator circuit coupled to the light sensing unit and conducting an integral operation on the sensing signal during integration, so as to accumulate the sensing signals to generate an accumulative sensing value falling within a default range.

2. The image sensing apparatus according to claim 1, wherein the light sensing unit comprises:
a reset switch with one end thereof coupled to a reset voltage, wherein the integration is a period when the reset switch is in a turned-off state;
a photoelectric conversion unit coupled between the other end of the reset switch and a ground and generating the sensing signal based on the light signal; and
a parasitic capacitance generated between a common contact of the photoelectric conversion unit and the reset switch and the ground, wherein the light sensing unit generates the sensing signal on the common contact.

3. The image sensing apparatus according to claim 2, further comprising:
a buffer amplifier circuit coupled to the integrator circuit, wherein the light sensing unit outputs the sensing signal to the integrator circuit through the buffer amplifier circuit.

4. The image sensing apparatus according to claim 3, further comprising:
a first switch;
a sampling capacitance connected in series with the first switch between an output end of the buffer amplifier circuit and the integrator circuit; and
a second switch coupled between a common contact of the first switch and the sampling capacitance and a reference voltage, wherein the first switch and the second switch are alternately turned on under a control of a first control signal and a second control signal respectively.

5. The image sensing apparatus according to claim 4, wherein the buffer amplifier circuit comprises:
an operational amplifier with a positive input end thereof coupled to the common contact of the photoelectric conversion unit and the reset switch, a negative input end of the operational amplifier coupled to an output end, and the output end of the operational amplifier used as the output end of the buffer amplifier circuit.

6. The image sensing apparatus according to claim 3, wherein the buffer amplifier circuit comprises:
a transistor with a first end thereof coupled to a supply voltage, a second end of the transistor coupled to an output end of the buffer amplifier circuit, a control end of the transistor coupled to the common contact of the photoelectric conversion unit and the reset switch; and
a current source coupled to the second end of the transistor.

7. The image sensing apparatus according to claim 3, wherein the buffer amplifier circuit comprises:
an operational amplifier with a positive input end thereof coupled to a reference voltage, a negative input end of the operational amplifier coupled to the common contact of the photoelectric conversion unit and the reset switch, and an output end of the operational amplifier used as an output end of the buffer amplifier circuit; and
a sampling capacitance coupled between the negative input end and the output end of the operational amplifier.

8. The image sensing apparatus according to claim 3, wherein the buffer amplifier circuit is disposed in the light sensing unit or integrated with the integrator circuit in an IC chip.
